(19) United States
(12) Patent Application Publication
(10) Pub. No.: US 2025/0117548 A1
(43) Pub. Date: Apr. 10, 2025

(54) LATTICE BOLTZMANN FLUID ANIMATION SIMULATION METHOD BASED ON IMPLICIT PARTICLE INTERPOLATION

(71) Applicant: Beihang University, Beijing (CN)

(72) Inventors: Yang GAO, Beijing (CN); Qingyue Qu, Beijing (CN); Aimin Hao, Beijing (CN); Dakun Sun, Beijing (CN)

(21) Appl. No.: 18/735,804

(22) Filed: Jun. 6, 2024

(30) Foreign Application Priority Data
Oct. 9, 2023 (CN) 2023113011573

(51) Int. Cl. G06F 30/25; G06F 30/23; G06F 113/08

(52) U.S. Cl. CPC G06F 30/25; G06F 30/23; G06F 2113/08

(57) ABSTRACT

Embodiments of the present disclosure provide a lattice Boltzmann fluid animation simulation method based on implicit particle interpolation. One specific implementation of the method includes: controlling each grid in a grid set to perform collision operations, and determining a distribution function after collision; based on the grid information contained in each grid in the grid set, moving an interface corresponding to the grid set; for each grid in the grid set, executing the following processing steps: performing a streaming of the distribution function on the grid to generate a function quantity of streaming, and determining a grid mass quantity of streaming based on the function quantity of streaming; updating the velocity of each particle on the grid; for each particle with updated velocity, updating the position of the particle; performing, based on a target area, a particle resampling process on each grid in the grid set.

### CROSS-REFERENCE TO RELATED APPLICATION

The present application is based on, and claims priority from, Chinese application number 2023113011573, filed on Oct. 9, 2023, the disclosure of which is hereby incorporated by reference herein in its entirety.

### TECHNICAL FIELD

Embodiments of the present disclosure relate to the field of fluid simulation technology in computer animation, and specifically to a lattice Boltzmann fluid animation simulation method based on implicit particle interpolation.

### BACKGROUND

Basic methods of fluid simulation may be divided into Eulerian method, Lagrangian method, and hybrid Eulerian-Lagrangian method, wherein the hybrid method has become a popular fluid simulation method because it integrates the advantages of the grid-based Eulerian method and the particle-based Lagrangian method. Methods based on implicit particles, such as FLIP, APIC, and MPM, have been widely studied. Although FLIP related methods are widely used, there are still challenges in increasing simulation's time efficiency and maintaining volume conservation.

However, when using the above methods for fluid simulation, there are often the following technical issues:

Iterative numerical calculation steps and a large number of particle operation steps are needed, which may consume a lot of time for fluid simulation. Besides, improved solutions for volume conservation in the prior art, as they increased the complexity of the algorithm, may further consume time for computing fluid simulation.

The above information disclosed in this background section is only intended to enhance understanding of the background of the concept of the present invention, and therefore, it may include information that does not constitute the prior art known to a person having ordinary skill in the art in this country.

### SUMMARY

The content of the present disclosure is intended to briefly introduce concepts, which will be described in detail in the section of detailed description later. The content of the present disclosure is not intended to identify key or necessary features of the claimed technical solution, nor is it intended to limit the scope of the claimed technical solution.

Some embodiments of the present disclosure propose a lattice Boltzmann fluid animation simulation method based on implicit particle interpolation, an apparatus thereof, an electronic equipment, and a computer-readable medium to solve one or more of the technical problems mentioned in the background section above.

In the first aspect, some embodiments of the present disclosure provide a lattice Boltzmann fluid animation simulation method based on implicit particle interpolation, the method comprising: controlling each grid in a grid set to perform collision operations, and determining a distribution function after collision; based on grid information contained in each grid in the grid set, moving an interface corresponding to the grid set; for each grid in the grid set, executing the following processing steps: performing a streaming of the distribution function on the grid to generate a function quantity of streaming, and determining a grid mass quantity of streaming based on the function quantity of streaming; updating a velocity of each particle on the grid; for each particle with an updated velocity, updating a position of the particle; performing, based on a target area, a particle resampling process on each grid in the grid set.

In the second aspect, some embodiments of the present disclosure provide a lattice Boltzmann fluid animation simulation apparatus based on implicit particle interpolation, the apparatus comprising: a control unit, configured to control each grid in a grid set to perform collision operations, and determine a distribution function after collision; a movement unit, configured to move, based on grid information contained in each grid in the grid set, an interface corresponding to the grid set; an execution unit, configured to execute, for each grid in the grid set, the following processing steps: performing a streaming of the distribution function on the grid to generate a function quantity of streaming, and determining a grid mass quantity of streaming based on the function quantity of streaming; updating a velocity of each particle on the grid; for each particle with an updated velocity, updating a position of the particle; and a particle resampling unit, configured to perform, based on a target area, a particle resampling process on each grid in the grid set.

In the third aspect, some embodiments of the present disclosure provide an electronic equipment, comprising: one or more processors; a storage device, on which one or more programs are stored, and when one or more programs are executed by one or more processors, the one or more processors are caused to implement the method described in any of the embodiments in the first aspect.

In the fourth aspect, some embodiments of the present disclosure provide a computer-readable medium on which a computer program is stored, wherein the method described in any of the embodiments in the first aspect is implemented when the program is executed by a processor.

The various embodiments of the present disclosure have the following beneficial effects: by the lattice Boltzmann fluid animation simulation method based on implicit particle interpolation in some embodiments of the present disclosure, the time for computing fluid simulation is reduced. To be specific, the reason for consuming a lot of time for fluid simulation consists in the need of iterative numerical calculation steps and a large number of particle operation steps, which will consume a lot of time in fluid simulation. Besides, improved solutions for volume conservation in the prior art, as they increased the complexity of the algorithm, may further consume time for computing fluid simulation. On this basis, the lattice Boltzmann fluid animation simulation method based on implicit particle interpolation in some embodiments of the present disclosure is, firstly, controlling each grid in a grid set to perform collision operations, and determining a distribution function after collision, thus the collision of surface fluids may be simulated, and the distribution function after collision determined; secondly, based on the grid information contained in each grid in the grid set, moving an interface corresponding to the grid set, thus the interface of the fluid may be moved; then, for each grid in the grid set, executing the following processing steps: firstly, performing a streaming of the distribution function on the grid to generate a function quantity of streaming, and determining a grid mass quantity of streaming based on the function quantity of streaming, thus the flow of the grid mass may be determined; secondly, updating the velocity of each particle on the grid, thus the velocity change of particles caused by mass flow may be determined; thirdly, for each particle with the updated velocity, updating the position of the particle, thus the positions of particles with changes in velocity may be updated; and lastly, based on a target area, performing a particle resampling process on each grid in the grid set, thus the fluid simulation is completed. By hybrid Eulerian-Lagrangian ideas, highly parallel computing, and using implicit interpolation particles, the efficiency of fluid simulation is improved, thereby reducing the time required for computing fluid simulation. Moreover, by resampling particles in narrowband regions, the number of particles is greatly reduced, thus saving particle operation time and further reducing the time for computing fluid simulation.

### BRIEF DESCRIPTION OF THE DRAWINGS

The above and other features, advantages, and aspects of the embodiments of the present disclosure will become more apparent in conjunction with the accompanying drawings and with reference to the following specific implementations. Throughout the drawings, the same or similar reference signs indicate the same or similar elements. It should be understood that the drawings are schematic, and the components and elements are not necessarily drawn to scale.

FIG. 1 is a flowchart of some embodiments of the lattice Boltzmann fluid animation simulation method based on implicit particle interpolation according to the present disclosure;

FIG. 2 is a structural schematic diagram of some embodiments of the lattice Boltzmann fluid animation simulation apparatus based on implicit particle interpolation according to the present disclosure;

FIG. 3 is a structural schematic diagram of an electronic equipment suitable for implementing some embodiments of the present disclosure.

### DETAILED DESCRIPTION OF THE INVENTION

Hereinafter, the embodiments of the present disclosure will be described in more detail with reference to the accompanying drawings. Although certain embodiments of the present disclosure are shown in the drawings, it should be understood that the present disclosure may be implemented in various forms, and shall not be construed as being limited to the embodiments set forth herein. On the contrary, these embodiments are provided for a more thorough and complete understanding of the present disclosure. It should be understood that the drawings and embodiments of the present disclosure are used only for illustrative purposes, not to limit the protection scope of the present disclosure.

Besides, it should be noted that, for ease of description, only the portions related to the relevant invention are shown in the drawings. In the case of no conflict, the embodiments in the present disclosure and the features in the embodiments may be combined with each other.

It should be noted that such concepts as “first” and “second” mentioned in the present disclosure are only used to distinguish different devices, modules or units, and are not used to limit the order of functions performed by these devices, modules or units or interdependence thereof.

It should be noted that such adjuncts as “one” and “more” mentioned in the present disclosure are illustrative, not restrictive, and those skilled in the art should understand that, unless the context clearly indicates otherwise, they should be understood as “one or more”.

The names of messages or information exchanged between multiple devices in the embodiments of the present disclosure are only for illustrative purposes, and are not intended to limit the scope of these messages or information.

The present disclosure will be described in detail below with reference to the accompanying drawings and in conjunction with embodiments.

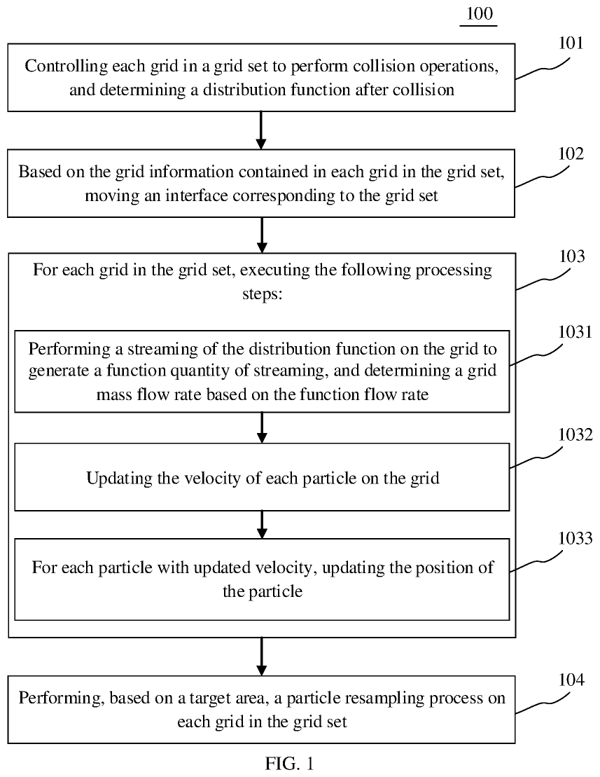

FIG. 1 illustrates a procedure 100 of some embodiments of the lattice Boltzmann fluid animation simulation method based on implicit particle interpolation according to the present disclosure. The lattice Boltzmann fluid animation simulation method based on implicit particle interpolation comprises the following steps:
Step 101, controlling each grid in a grid set to perform collision operations, and determining a distribution function after collision.

In some embodiments, the execution body (such as a server) of the lattice Boltzmann fluid animation simulation method based on implicit particle interpolation may control each grid in a grid set to perform collision operations, and determine a distribution function after collision. Wherein, the collision operations may be carried out through a single relaxation collision model. Here, the distribution function after collision may be represented by the following formula:

$${f}_{i}^{′} ( x , t ) = ( 1 - \frac{1}{τ} ) {f}_{i} ( x , t ) + \frac{1}{τ} {f}_{i}^{e q} ( x , t ) .$$

Wherein, f′ᵢ represents the distribution function after collision. fᵢ represents the distribution function. x represents position. t represents the current time. τ represents the relaxation time. fᵢ^{eq} represents an equilibrium state distribution function, i represents the dimension of velocity discreteness, and eq represents the equilibrium state. Here, the equilibrium state distribution function may be determined through the following formula:

$${f}_{i}^{e q} = {ω}_{i} ρ [ 1 + \frac{{c}_{i} \cdot u}{{c}_{s}^{2}} + \frac{{( {c}_{i} \cdot u )}^{2}}{2 {c}_{s}^{4}} - \frac{{u}^{2}}{2 {c}_{s}^{2}} ] .$$

Wherein, cᵢ represents the normalized discrete velocity of the lattice model. u represents velocity. ωᵢ represents weight. ρ represents density. cₛ represents the speed of sound. The above lattice model may be a discrete velocity model of the grid, which includes the discrete numbers of the spatial dimensions and velocity. For example, in response to the space being a three-dimensional space, velocity is discretized into 19 directions, the above lattice model may be a D3Q19 lattice model. Here, ρ and u may be represented by the following formula respectively:

$$ρ = {\sum }_{i} {f}_{i} , ρ u = {\sum }_{i} {c}_{i} {f}_{i} .$$

Step 102, based on the grid information contained in each grid in the grid set, moving an interface corresponding to the grid set.

In some embodiments, the execution body may move an interface corresponding to the grid set based on the grid information contained in each grid in the grid set. Wherein, the grid information may be grid mass. The above interface may include a plurality of interface grids. In practice, the movement of the interface may be determined through the following formula:

$$\begin{matrix}m ( x , t + Δ t ) & > ( 1 + κ ) ρ ( x , t + Δ t ) & filled grid \\ m ( x , t + Δ t ) & < ( 0 - κ ) ρ ( x , t + Δ t ) & emptied grid\end{matrix} .$$

Wherein, κ=10⁻³, κ represents the threshold to prevent frequent interface conversions. Δt represents the time step size. The filled grid and the emptied grid may be two types of intermediate grids. To ensure the closure of the interface, it is necessary to reinitialize the grid type based on these two intermediate types. Firstly, for the various air grids around the filled grid, convert each air grid in the various air grids into an interface grid. The distribution functions of the various air grids mentioned above use fᵢ^{eq} (ρ^{avg}, u^{avg}) to initialize. Wherein, ρ^{avg} represents the average density of the grids around a certain air grid, u^{avg} represents the average velocity of the grids around a certain air grid, and avg represents the average value. Secondly, the filled grid is converted into a fluid grid, and the air grids around the filled grid are converted into interface grids. Thirdly, all air grids around the cleared grid are converted into interface grids. Thus, the interface of the fluid may be moved.

When moving the interface of the fluid, due to the default mass of the fluid grid m=ρ, the mass of the air grid is m=0, and after interface movement occurs, loss of mass will result. To ensure mass conservation, it is necessary to allocate excessive mass when converting the two intermediate grid types into fluid or air grids:

$$m ( x + {c}_{i} ) = m ( x + {c}_{i} ) + {m}^{e x} ( \frac{{w}_{i}}{{w}_{total}} ) .$$

Wherein, m^{ex} represents excessive mass. wₜₒₜₐₗ represents the sum of all wᵢ, ex represents excess, and total represents sum. wᵢ may be represented by the following formula:

$${w}_{i} = \{ \begin{matrix}n \cdot {c}_{i} , & if n \cdot {c}_{i} > 0 & \\ & & filled grid \\ 0 , & others & \end{matrix}$$

$${w}_{i} = \{ \begin{matrix}- n \cdot {c}_{i} , & if n \cdot {c}_{i} < 0 & \\ & & emptied grid . \\ 0 , & others & \end{matrix}$$

Wherein, n represents the normal direction of the interface.
Step 103, for each grid in the grid set, executing the following processing steps:
Step 1031, performing a streaming of the distribution function on the grid to generate a function quantity of streaming, and determining a grid mass quantity of streaming based on the function quantity of streaming.

In some embodiments, the execution body may perform a streaming of the distribution function on the grid to generate a function quantity of streaming, and determine a grid mass quantity of streaming based on the function quantity of streaming. In practice, the execution body may execute the streaming of the distribution function through the following formula:

$${f}_{i} ( x + {c}_{i} Δ t , t + Δ t ) = {f}_{i}^{′} ( x , t ) .$$

Therefore, the grid mass quantity of streaming may be determined through the following formula:

$$Δ {m}_{i} ( x , t + Δ t ) = ( {f}_{\tilde{ι}} ( x + {c}_{i} , t ) - {f}_{i} ( x , t ) ) \cdot \frac{( ε ( x + {c}_{i} , t ) + ε ( x , t ) )}{2} .$$

Wherein, \tilde{l} represents the opposite direction of i. ε represents the volume fraction. Δm represents the change in mass. Δmᵢ represents the change in mass in the i direction. The total mass of the grid is computed from the change in mass in each direction:

$$m ( x , t + Δ t ) = m ( x , t ) + \sum Δ {m}_{i} ( x , t + Δ t ) .$$

Due to the distribution function fᵢ=0 of the air grid, the distribution function from the direction of the air grid needs to be reconstructed. To balance the forces on both sides of the interface, the forces from the normal direction of the interface should also be reconstructed. The computing mode for the reconstructed distribution function is:

$${f}_{\tilde{ι}}^{′} ( x , t + Δ t ) = {f}_{i}^{e q} ( {ρ}_{A} , u ) + {f}_{ĩ}^{e q} ( {ρ}_{A} , u ) - {f}_{i} ( x , t ) .$$

Wherein, ρ_{A}=1 represents the density of air. The normal direction satisfies:

$$n \cdot {c}_{\tilde{ι}} > 0 , n = \frac{1}{2} ( \begin{matrix}ε ( {x}_{j - 1 , k , l} ) - ε ( {x}_{j + 1 , k , l} ) \\ ε ( {x}_{j , k - 1 , l} ) - ε ( {x}_{j , k + 1 , l} ) \\ ε ( {x}_{j , k , l - 1} ) - ε ( {x}_{j , k , l + 1} )\end{matrix} ) .$$

Wherein, j represents the position of the length dimension in three-dimensional space. k represents the position in the width direction in three-dimensional space. l represents the position of the height dimension in three-dimensional space.

To maintain the stability of the simulation, it is necessary to adjust the time step size.
Step 1032, updating the velocity of each particle on the grid.

In some embodiments, the execution body may update the velocity of each particle on the grid. Here, in response to the cumulative time step reaching 1.0, the execution body may update the velocity of each particle on the grid. Wherein, the velocity is a vector velocity.

In some optional implementations of some embodiments, for each particle on the grid, the velocity and velocity increment of the particle may be determined, and the velocity of the particle may be updated based on the velocity and velocity increment. Here, by means of trilinear interpolation, the velocity and velocity increment (the change in velocity before and after collision) stored on the grid are transmitted to the particle:

$$\begin{matrix}{u}_{o} = {\sum }_{v} {u}_{v} S ( {x}_{v} - {x}_{o} ) \\ \frac{d {u}_{o}}{d t} = {\sum }_{v} \frac{d {u}_{v}}{d t} S ( {x}_{v} - {x}_{o} )\end{matrix} .$$

Wherein, uᵥ represents the velocity stored on the grid, xᵥ represents the grid position, xₒ represents the particle position, uₒ represents the particle velocity, grid variables are stored at the center point of the grid, and d represents the differential symbol, S( ) represents a trilinear interpolation function, o represents the o^{th} particle, v represents the v^{th} grid. Here, only the fluid grid and the interface grid have effective velocities, so particles near the interface may have under-sampling issues during interpolation. Therefore, it is necessary to extrapolate the velocity of the interface grid by one layer, that is, the velocity of a layer of air grid adjacent to the interface grid is equal to the velocity of its neighboring interface grid.

Velocity of updated particles:

$${u}_{o} ← ( 1 - α ) {u}_{i o}^{PIC} + α {u}_{o}^{FLIP} .$$

Wherein, α represents a parameter similar to classical FLIP, for controlling dissipation. uᵢₒ^{PIC} represents the velocity obtained from grid interpolation, uₒ^{FLIP} represents the velocity increment obtained from grid interpolation, while PIC and FLIP represent different simulation methods respectively.
Step 1033, for each particle with updated velocity, updating the position of the particle.

In some embodiments, the execution body, for each particle with updated velocity, may update the position of the particle. In practice, the position of a particle may be updated through the semi-Lagrangian method. Here, the time step for updating the position of a particle is 1.
Step 104, performing, based on a target area, a particle resampling process on each grid in the grid set.

In some embodiments, the execution body may perform a particle resampling process on each grid in the grid set based on a target area.

In practice, the particle resampling process may be performed on each grid in the grid set by following the steps:
The first step is to perform the following first resampling steps in response to the target area characterizing a fluid region:
The first sub-step is to perform a particle filling process, on at least one grid that meets a first filling condition, in the grid set. Wherein, the first filling condition may be that the number of particles on the grid is less than a preset number of particles. In practice, the particle filling process may be to fill the particles on the grid to the preset number of particles. In practice, before the collision operation performed in step 101, each grid is filled with Y particles. As an example, Y may be 8. The volume of each particle is εₚ=1/Y. For each fluid grid, in response to the number of particles being less than ε/εₚ, supplement the number of particles to ε/ε_{O}. The velocity of the supplemented particles is equal to the average velocity of other particles in the grid. If there are no particles in the grid before filling, the initial velocity is obtained through trilinear interpolation.

The second sub-step is to have the particles on at least one grid in the grid set that meets a preset removal condition removed to a preset number of particles. Wherein, the preset removal condition may be that the number of particles on the grid is greater than a preset removal threshold, and the grid is not an interface grid. The preset removal threshold may be the maximum value of particles on a preset grid. For example, the preset removal threshold may be 1.5ε/εₒ. To avoid artifacts, particles in the interface grid are not removed.

Optionally, after the first step, perform the following second resampling step, in response to the target area characterizing a narrowband region:
The first sub-step is to initialize a level set field of the grid. Here, the initialized level set field ϕ may be represented by the following formula:

$$ϕ = \{ \begin{matrix}- 0.5 Δ x & interface grid \\ + ∞ & air grid \\ - ∞ & fluid grid \\ 0 & obstale grid\end{matrix} .$$

The second sub-step is to initialize a scalar field of the grid. Wherein, the scalar field L is used to represent the level of the grid, making the interface grid L=0. The condition for defining two grids whose positions are x₁ and x₂ to be adjacent is that their Euclidean distance is equal to 1, i.e. |x₁−x₂|=1. Thereafter, a level-based method is employed to compute the L of the remaining grid. If a grid is adjacent to the grid of the last layer, its level is:

$$L = {L}_{last} + s .$$

Wherein, for a fluid grid, s=−1, and for an air grid, s=1. To meet the requirements of narrowband solutions, calculating up to r+2 layers is enough, wherein r represents the narrowband width. The level of the remaining grid is L=s·(r+3), wherein, last represents the last layer of grid, and Lₗₐₛₜ represents the scalar field of the laser layer of grid.

The third sub-step is to select each grid that meets a preset grid condition from the grid set as a target grid set. Wherein, the grid that meets the preset grid condition may be a grid other than the interface grid.

The fourth sub-step is to determine a level set value based on the target grid set. Here, the level set value of the target grid set may be determined. In practice, the level set value may be determined by the following formula:

$$ϕ = {ϕ}_{last}^{avg} + s \cdot Δ x .$$

Wherein, ϕₗₐₛₜ^{avg} represents an average of the level set value of the last layer of grid. For an obstacle grid, make the level set value of the obstacle grid equal to the value of its adjacent non-obstacle grid.

The fifth sub-step is to perform a second resampling process on each grid in the grid set based on the level set value mentioned above. In practice, firstly, the particle filling process may be applied to at least one grid in the grid set that meets the first filling condition, within a preset area range. The preset area range may be −1.0<ϕ<−r. Secondly, particles on at least one grid in the grid set that meets a preset removal condition may be removed to a preset number of particles within the preset area range. In addition, there are two types of particles that need to be removed, namely redundant particles within the narrowband region and particles outside the narrowband region. The level set value ϕᵢ of each particle is obtained through the level set field ϕ on a trilinear interpolation grid.

The various embodiments of the present disclosure have the following beneficial effects: by the lattice Boltzmann fluid animation simulation method based on implicit particle interpolation in some embodiments of the present disclosure, the time for computing fluid simulation is reduced. To be specific, the reason for consuming a lot of time for fluid simulation consists in the need of iterative numerical calculation steps and a large number of particle operation steps, which will consume a lot of time in fluid simulation. Besides, improved solutions for volume conservation in the prior art, as they increased the complexity of the algorithm, may further consume time for computing fluid simulation. On this basis, the lattice Boltzmann fluid animation simulation method based on implicit particle interpolation in some embodiments of the present disclosure is, firstly, controlling each grid in a grid set to perform collision operations, and determining a distribution function after collision, thus the collision of surface fluids may be simulated, and the distribution function after collision determined. Secondly, based on the grid information contained in each grid in the grid set, moving an interface corresponding to the grid set, thus the interface of the fluid may be moved; then, for each grid in the grid set, executing the following processing steps: firstly, performing a streaming of the distribution function on the grid to generate a function quantity of streaming, and determining a grid mass quantity of streaming based on the function quantity of streaming, thus the flow of the grid mass may be determined; secondly, updating the velocity of each particle on the grid, thus the velocity change of particles caused by mass flow may be determined; thirdly, for each particle with the updated velocity, updating the position of the particle, thus the positions of particles with changes in velocity may be updated; lastly, based on a target area, performing a particle resampling process on each grid in the grid set, thus the fluid simulation is completed. By hybrid Eulerian-Lagrangian ideas, highly parallel computing, and using implicit interpolation particles, the efficiency of fluid simulation is improved, thereby reducing the time required for computing fluid simulation. Moreover, by resampling particles in narrowband regions, the number of particles is greatly reduced, thus saving particle operation time and further reducing the time for computing fluid simulation.

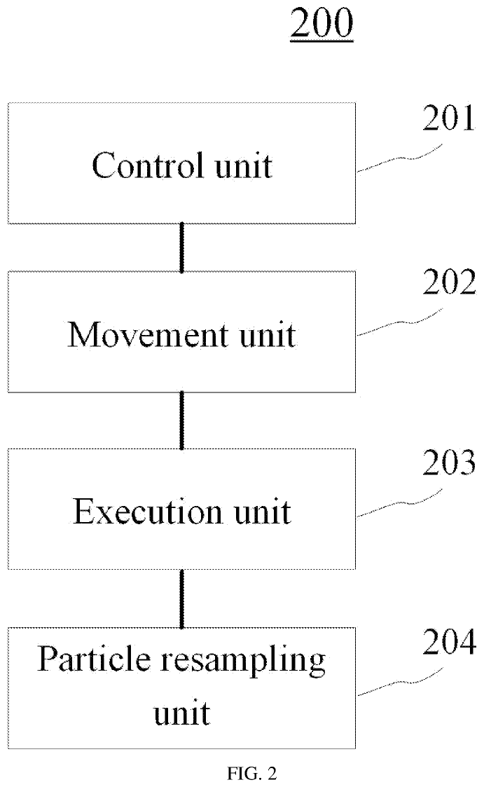

Further referring to FIG. 2, as an implementation of the methods shown in the above drawings, the present disclosure provides some embodiments of a lattice Boltzmann fluid animation simulation apparatus based on implicit particle interpolation, which correspond to the method embodiments shown in FIG. 1. The lattice Boltzmann fluid animation simulation apparatus based on implicit particle interpolation may be specifically applied to various electronic equipment.

As shown in FIG. 2, the lattice Boltzmann fluid animation simulation apparatus 200 based on implicit particle interpolation of some embodiments comprises: a control unit 201, a movement unit 202, an execution unit 203, and a particle resampling unit 204. Wherein, the control unit 201 is configured to control each grid in a grid set to perform collision operations, and determine a distribution function after collision; the movement unit 202 is configured to move an interface corresponding to the grid set based on the grid information contained in each grid in the grid set; the execution unit 203 is configured to execute the following processing steps for each grid in the grid set: performing a streaming of the distribution function on the grid to generate a function quantity of streaming, and determining a grid mass quantity of streaming based on the function quantity of streaming; updating the velocity of each particle on the grid; for each particle with the updated velocity, updating the position of the particle; and the particle resampling unit 204 is configured to perform, based on a target area, a particle resampling process on each grid in the grid set.

It may be understood that the units in the lattice Boltzmann fluid animation simulation apparatus 200 based on implicit particle interpolation correspond to the steps in the method described in FIG. 1. Therefore, the operations, features, and beneficial effects described above for the method are also applicable to the lattice Boltzmann fluid animation simulation apparatus 200 based on implicit particle interpolation and the units contained therein, and will be discussed no more.

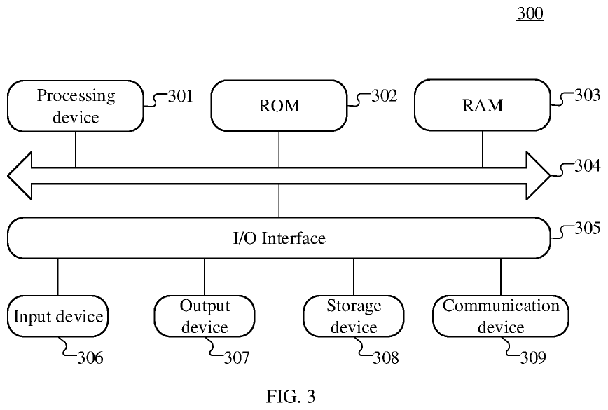

Referring to FIG. 3 below, a structural schematic diagram of an electronic equipment 300 suitable for implementing some embodiments of the present disclosure is shown. The electronic equipment in the disclosed embodiments may include, but is not limited to, mobile terminals such as mobile phones, laptops, digital broadcast receivers, PDAs (personal digital assistants), PADs (tablets), PMPs (portable multimedia players), vehicle terminals (such as vehicle navigation terminals), and fixed terminals such as digital TVs, desktop computers, and the like. The electronic equipment shown in FIG. 3 is only an example and should not impose any limitations on the functionality and scope of use of the disclosed embodiments.

As shown in FIG. 3, the electronic equipment 300 may include a processing device 301 (such as a central processing unit, graphics processor, etc.) that can perform various appropriate actions and processes based on programs stored in a read-only memory (ROM) 302 or programs loaded from a storage device 308 to a random access memory (RAM) 303. In the RAM 303, various programs and data required for the operation of the electronic equipment 300 are also stored. The processing device 301, ROM 302, and RAM 303 are connected to each other through a bus 304. An input/output (I/O) interface 305 is also connected to the bus 304.

In general, the following devices may be connected to the I/O interface 305: input devices 306 including, for example, touch screens, touchpads, keyboards, mice, cameras, microphones, accelerometers, gyroscopes, etc.; output devices 307 including, for example, liquid crystal displays (LCDs), speakers, vibrators, etc.; storage devices 308 including, for example, magnetic tapes, hard drives, etc.; and a communication device 309. The communication device 309 may allow the electronic equipment 300 to have wireless or wired communication with other equipment to exchange data. Although FIG. 3 illustrates an electronic equipment 300 with various devices, it should be understood that it is not required to implement or possess all the shown devices. It may be alternatively implemented or equipped with more or fewer devices. Each box shown in FIG. 3 may represent one device or multiple devices as needed.

Specifically, according to some embodiments of the present disclosure, the process described above with reference to the flowchart may be implemented as a computer software program. For example, some embodiments of the present disclosure include a computer program product comprising a computer program carried on a computer-readable medium, the computer program comprising a program code for executing the method shown in the flowchart. In some such embodiments, the computer program may be downloaded and installed from the network through the communication device 309, or installed from the storage device 308, or installed from the ROM 302. When the computer program is executed by the processing device 301, the above-mentioned functions defined in some embodiments of the present disclosure are executed.

It should be noted that the computer-readable medium documented in some embodiments of the present disclosure may be a computer-readable signal medium, a computer-readable storage medium, or any combination of the two. The computer-readable storage medium, for example, may be but is not limited to an electrical, magnetic, optical, electromagnetic, infrared, or semiconductor system, apparatus, or components, or any combination thereof. More specific examples of the computer-readable storage medium may include, but are not limited to: electrical connections with one or more wires, portable computer disks, hard drives, random access memory (RAM), read-only memory (ROM), erasable programmable read-only memory (EPROM or flash), optical fibers, portable compact disk read-only memory (CD-ROM), optical storage devices, magnetic storage devices or any suitable combination thereof. In some embodiments of the present disclosure, a computer-readable storage medium may be any tangible medium containing or storing a program, which may be used by or in combination with an instruction execution system, apparatus, or components. In some embodiments of the present disclosure, the computer-readable signal medium may include data signals propagated in the baseband or as part of the carrier wave, carrying computer-readable program code therein. This type of propagated data signal may take various forms, including but not limited to electromagnetic signals, optical signals, or any suitable combination thereof. The computer-readable signal medium may also be any computer-readable medium other than a computer-readable storage medium. The computer-readable signal medium may send, propagate, or transmit programs for use by or in combination with an instruction execution system, apparatus, or components. The program code contained on a computer-readable medium may be transmitted using any appropriate medium, including but not limited to: wires, optical cables, RF (radio frequency), etc., or any suitable combination thereof.

In some implementations, clients and servers may communicate using any currently known or future developed network protocol, such as HTTP (HyperText Transfer Protocol), and may interconnect with any form or medium of digital data communication (such as communication networks). Examples of communication networks include local area networks (LANs), wide area networks (WANs), internets (e.g. Internet), and end-to-end networks (e.g. ad hoc end-to-end networks), as well as any currently known or future developed networks.

The computer-readable medium may be included in the electronic equipment, or may also exist separately without being assembled into the electronic equipment. The computer-readable medium carries one or more programs, which, when executed by the electronic equipment, cause the electronic equipment to: control each grid in a grid set to perform collision operations, and determine a distribution function after collision; based on the grid information contained in each grid in the grid set, move an interface corresponding to the grid set; for each grid in the grid set, execute the following processing steps: performing a streaming of the distribution function on the grid to generate a function quantity of streaming, and determining a grid mass quantity of streaming based on the function quantity of streaming; updating the velocity of each particle on the grid; for each particle with the updated velocity, updating the position of the particle; performing, based on a target area, a particle resampling process on each grid in the grid set

Computer program code for executing some embodiments of the present disclosure may be written in one or more programming languages or combinations thereof, including object-oriented programming languages such as Java, Smalltalk, C++, and conventional procedural programming languages such as C or similar programming languages. Program code may be completely executed on the user's computer, partially executed on the user's computer, executed as an independent software package, partially executed on the user's computer and partially executed on a remote computer, or completely executed on a remote computer or server. In cases involving a remote computer, the remote computer may connect to user computers through any type of network, including local area networks (LANs) or wide area networks (WANs), or may connect to external computers (such as using internet service providers to connect via the Internet).

The flowchart and block diagram in the accompanying drawings illustrate the possible architectures, functions, and operations of the system, methods, and computer program products according to various embodiments of the present disclosure. At this point, each box in the flowchart or block diagram may represent a module, program segment, or part of code, and the module, program segment, or part of code contains one or more executable instructions for implementing specified logical functions. It should also be noted that in some alternative implementations, the functions indicated in the boxes may also occur in a different order than those indicated in the accompanying drawings. For example, two consecutive boxes may actually be executed in parallel basically, and sometimes they may also be executed in opposite order, depending on the functionality involved. It should also be noted that each box in the block diagram and/or flowchart, as well as the combination of boxes in the block diagram and/or flowchart, may be implemented using dedicated hardware-based systems that perform specified functions or operations, or may be implemented using a combination of dedicated hardware and computer instructions.

The units described in some embodiments of the present disclosure may be implemented through software or hardware. The described units may also be set in a processor, for example, it may be described as: a processor comprising a control unit, a movement unit, an execution unit, and a particle resampling unit. Wherein, the names of these units do not constitute limitations to the units per se in some cases. For example, the control unit may also be described as “a unit that controls each grid in a grid set to perform collision operations, and determines a distribution function after collision”.

The functions described above in this article may be at least partially performed by one or more hardware logic components. For example, non-restrictively, demonstration types of hardware logic components that may be used include: Field Programmable Gate Arrays (FPGAs), Application Specific Integrated Circuits (ASICs), Application Specific Standard Products (ASSPs), Systems on Chip (SOC), Complex Programmable Logic Devices (CPLDs), and so on.

The above description is merely some preferred embodiments of the present disclosure and illustrations of the applied technical principles. Those skilled in the art should understand that the scope of the invention involved in the embodiments of the present disclosure is not limited to the technical solutions formed by the specific combination of the above technical features, but should cover at the same time, without departing from the above inventive concept, other technical solutions formed by any combination of the above technical features or their equivalent features, for example, a technical solution formed by replacing the above features with the technical features of similar functions disclosed in (but not limited to) the embodiments of the present disclosure.

1. A lattice Boltzmann fluid animation simulation method based on implicit particle interpolation, comprising:
controlling each grid in a grid set to perform collision operations, and determining a distribution function after collision;
based on grid information contained in each grid in the grid set, moving an interface corresponding to the grid set;
for each grid in the grid set, executing the following processing steps:
performing a streaming of the distribution function on the grid to generate a function quantity of streaming, and determining a grid mass quantity of streaming based on the function quantity of streaming;
updating a velocity of each particle on the grid;
for each particle with an updated velocity, updating a position of the particle; and
performing, based on a target area, a particle resampling process on each grid in the grid set.

2. The method of claim 1, wherein the updating the velocity of each particle on the grid, comprises:
for each particle on the grid, determining the velocity and a velocity increment of the particle, and updating the velocity of the particle based on the velocity and the velocity increment.

3. The method of claim 1, wherein the performing, based on a target area, a particle resampling process on each grid in the grid set, comprises:
performing the following first resampling steps in response to the target area characterizing a fluid region:
performing a particle filling process on at least one grid in the grid set that meets a first filling condition; and
having particles on at least one grid in the grid set that meets a preset removal condition removed to a preset number of particles.

4. The method of claim 3, wherein the performing, based on a target area, a particle resampling process on each grid in the grid set, further comprises:
performing the following second resampling steps in response to the target area characterizing a narrowband region:
initializing a level set field of the grid;
initializing a scalar field of the grid;
selecting each grid that meets a preset grid condition from the grid set, as a target grid set;
determining a level set value based on the target grid set;
performing a second resampling process on each grid in the grid set based on the level set value.

5. A lattice Boltzmann fluid animation simulation apparatus based on implicit particle interpolation, comprising:
a control unit, configured to control each grid in a grid set to perform collision operations, and determine a distribution function after collision;
a movement unit, configured to move, based on grid information contained in each grid in the grid set, an interface corresponding to the grid set;
an execution unit, configured to execute, for each grid in the grid set, the following processing steps: performing a streaming of the distribution function on the grid to generate a function quantity of streaming, and determining a grid mass quantity of streaming based on the function quantity of streaming;
updating a velocity of each particle on the grid;
for each particle with an updated velocity, updating a position of the particle; and
a particle resampling unit, configured to perform, based on a target area, a particle resampling process on each grid in the grid set.

6. An electronic equipment, comprising:
one or more processors;
a storage device, on which one or more programs are stored;
when the one or more programs are executed by the one or more processors, the one or more processors are caused to implement the method described in claim 1.

7. A computer-readable medium, on which a computer program is stored, wherein the method described in claim 1 is implemented when the program is executed by a processor.
